(19) United States
(12) Patent Application Publication
(10) Pub. No.: US 2026/0244063 A1
(43) Pub. Date: Aug. 20, 2026

(54) Light manipulation and sensing based on geometric reconfiguration of nanoscale optical systems

(71) Applicant: The Board of Trustees of the Leland Stanford Junior University, Stanford, CA (US)

(72) Inventors: Siddharth Doshi, Stanford, CA (US); Anqi Ji, Redwood City, CA (US); Mark L. Brongersma, Menlo Park, CA (US); Nicholas A Melosh, Menlo Park, CA (US)

(21) Appl. No.: 18/992,718

(22) PCT Filed: Jul. 11, 2023
(86) PCT No.: PCT/US2023/027400

§ 371 Date: Jan. 9, 2025

Related U.S. Application Data
(60) Provisional application No. 63/388,124, filed on Jul. 11, 2022.

(51) Int. Cl. G02F 1/157; G01N 21/552; G01N 21/59

(52) U.S. Cl. CPC G02F 1/157; G01N 21/554; G01N 21/59; G01N 2021/5903; G01N 2201/0666

(57) ABSTRACT

Tunable optical metasurfaces for amplitude and phase control of light are provided based on electrochemical tuning of the thickness of a polymer spacer between metal structures. The resulting Fabry-Perot and/or plasmon resonances are thereby made tunable, with a figure of merit that can greatly exceed the figure of merit for electrochromic tuning. This operating principle can be generalized to provide optical sensing of various environmental parameters such as humidity, pressure etc.

### FIELD OF THE INVENTION

This invention relates to optical metasurfaces for light manipulation and sensing applications.

### BACKGROUND

Active manipulation of light beams could include temporal or spatial modulation of various properties of light. Such properties include, but not limited to, the amplitude, phase, polarization state, angular momentum, spectral and statistical distribution (e.g. speckles) of light and the shape of its wave fronts. Active manipulation of light is required for a range of emerging optical technologies, including sensing, optical computing, virtual/augmented reality, dynamic holography and computational imaging. Miniaturization of these optical components is key to facilitating their integration into a range of applications. Despite many advances, the size and weight of traditional macroscopic lenses and dynamic optical elements, tuned using dielectric elastomers (e.g. Optotune products), or electrowetting, mechanical or thermal approaches still take up significant space due to their use of classic optical elements. Therefore it is highly desirable to reduce the size and weight of the dynamic optical components in such systems.

Subwavelength control over the phase using ordered arrays of nanoantennae, or metasurfaces, could allow this goal to be achieved. Tunable metasurface lenses have been realized and typically use strain or thermal tuning of the entire metasurface or mechanical movement between metasurface lenses. Recent efforts have demonstrated impressive modulation of phase and color of pixel elements that could be individually actuated with high speed MEMs technology. However, these are challenging to fabricate and experience limitations in dynamic applications due to vibration instability. Other recent efforts have shown electrically tunable conductive polymer metasurfaces, however, these are only active in the “invisible” NIR/IR regimes due to inherent limitations of the polymers used.

Additionally, we note that fluidic approaches (e.g. by changing droplet contact angle) to lensing and optical manipulation have been widely explored and found use in industrial application, but these techniques have yet to extend to flat and nanoscale optical elements. Additionally, front lit display elements such as the Kindle® make use of microfabricated dielectrophoretically switched fluid elements. Nanoscale optical elements, combined with rapid advances in microfluidic systems infrastructure, could enable the next generation of optical elements light control.

### SUMMARY

We have a developed a hybrid polymer/metal tunable optical metasurface system, with operation in wavelength ranges from the visible to the infrared, with potential to cover the UV to THz range. We can reversibly tune the color and phase of reflected wave fronts through applications of suitable fluids to the surface of the metasurface. The fluid infiltrates into the polymer, causing a change in swelling degree of the polymer. Depending on the specific design chosen, this can result in a change of the reflected color from the metasurface, continuous tuning of the direction of the reflected beam, or on-off modulation between different diffraction orders.

Our metasurface includes a base metal “mirror” layer, a polymer spacer layer, and a patterned top layer metal having nano-gratings or nano-antennae. This system supports a set of coupled plasmonic and Fabry-Perot resonances which allow for control of the phase of scattered light over a broad range.

Sub-wavelength metallic structures display a range of plasmonic resonances that depend on their material properties and geometry. The placement of the base metal “mirror” layer below the metallic nanostructure creates a resonant cavity, leading to a structural color that can be tuned by changing the height of the nanostructure above the mirror. We fabricate our device by patterning plasmonic (metal) nanostructures onto a polymer spacer layer that has been deposited on the bottom mirror. This polymer spacer layer thickness can be tuned by the environment. In sensor applications, any environmental parameter that affects the polymer spacer thickness can, in principle, be sensed. For light manipulation and control applications, electrochemical tuning is preferred, where the metasurface is disposed in an electrochemical cell, and a voltage is applied to the cell to control the polymer thickness. This allows us to exploit the advantages of an electrical control input combined with the advantages of the underlying polymer swelling mechanism. In one particular implementation, we use the commercially available polymer, PEDOT:PSS. Other polymers, such as various classes of hydrogels, can be patterned and tuned in a similar manner.

Additionally, light scattered from the antennas experiences a phase shift based on the geometry of the antennae. By modifying the geometry of different antennae, a phase gradient can be introduced to light scattered from the antenna, which can result in overall change in direction of a reflected diffractive order (i.e. beam steering). This is a widely known concept in wave manipulation and has been utilized widely in the field of metasurfaces. Typically, this phase manipulation and resultant light control is fixed upon fabrication of the device. It is highly desirable to dynamically modulate the properties of the system after fabrication, ideally in an energy efficient manner.

To do so using our polymer swelling system, we firstly note that the phase shift experienced by a given antenna can be modified by the interaction with reflected light from the bottom mirror. By careful engineering, a structure can be designed such that the phase gradient and hence beam direction can be modified by changing the thickness of the polymer spacer between the top nanoantennae and bottom metal mirror. For example, this can result in some elements experiencing weak phase variation with thickness, and other elements experiencing stronger phase variation with thickness, thereby changing the resultant phase gradient. Alternately, a modulator can be designed such that the modulator switches from high efficiency in the 0th diffractive order (normal reflection) to the 1st diffracted order (reflection towards some angle) by moving the nanostructures from an anti-node to a node of the reflected light field.

In addition to periodic metasurfaces as in some of the preceding examples, embodiments of the invention can also be configured as aperiodic devices (e.g., single resonator structures and the like). This is expected to be especially helpful in sensor applications, where an array of such individual devices can form a sensor array.

Applications include but are not limited to the following:
1) We envisage that this could lead to flat, wavelength specific, dynamically tunable focusing devices. Traditional optics based on centimeter or millimeter scale solid glass or plastic lenses are moved back and forth to focus or zoom. In contrast, this system can be made ultracompact and avoids the use of complex mechanics. Response times of <100 ms could be of benefit to high throughput systems. The use of electrochemical tuning allows for reliable and durable operation without typical mechanical wear.
2) Such dynamically tunable fluidic systems may find use in virtual/augmented or wearable optical systems, where they can avoid strong vibration sensitivity associated with current microelectromechanical (MEMS) tuning (albeit at lower speeds).
3) Optical information processing uses the diffraction of light through patterned elements to physically implement mathematical operations. Rather than have the transfer function of the system set during fabrication, it would be of benefit to be able to tune the optical system during operations (e.g. set weights).
4) The system can be directly integrated into microfluidic system for inline sensing of system parameters, including potentially concentrations of biomolecules (e.g. with modifications of the polymer). We note that this has advantages that this isn't a simple refractive index sensor, but rather transduces a physical property of the solution into swelling, which is detected by the optical system.

Significant advantages are provided.

In contrast to conventional millimeter to centimeter scale optical elements, these ultra-thin devices can be made with thicknesses of <500 nm.

While we have demonstrated our concept with a particular polymer (PEDOT), the principle is applicable for a range of other polymers (e.g. hydrogels). Therefore, we envisage that the system could be useful in applications including low power optical modulators, reconfigurable optical devices (including reconfigurable lensing and display), and sensing systems directly integrated into nano/microfluidic systems.

### BRIEF DESCRIPTION OF THE DRAWINGS

FIGS. 1A-B show operating principles of embodiments of the invention.

FIGS. 1C-E show color switching characterization of an embodiment of the invention.

FIGS. 2A-D show amplitude and phase response characterization for an embodiment of the invention.

FIGS. 3A-3E show design considerations relating to an embodiment of the invention configured for beam steering.

FIGS. 4A-D show an example of beam steering with an embodiment of the invention.

FIGS. 5A-C shows a comparison of swelling-based tuning to electrochromic tuning.

FIGS. 6A-C relate to application of an embodiment of the invention to hyperspectral imaging.

FIG. 7 shows an asymmetric metasurface feature suitable for use in embodiments of the invention that relate to polarization control.

FIGS. 8A-B schematically show a tunable waveguide coupler according to an embodiment of the invention.

FIG. 9 shows a sensor concept enabled by embodiments of the invention.

### DETAILED DESCRIPTION

Section A describes general principles relating to embodiments of the invention. Section B describes in detail an experimental example of this work.

### A) General Principles

An exemplary embodiment of the invention is apparatus for controlling phase and amplitude of light, where the apparatus includes: an electrochemical cell; and an optical metasurface including metasurface feature(s) having optical resonance(s), where the metasurface feature(s) include a first metal structure and a second metal structure sandwiching a polymer.

The optical metasurface is disposed within the electrochemical cell, and the thickness of the polymer between the first metal structure and the second metal structure is electrochemically tunable by applying a voltage to the electrochemical cell, thereby altering one or more optical properties of the optical resonance to control a phase response and an amplitude response of the optical metasurface.

Here an optical metasurface is a generally planar structure having sub-wavelength features with sub-wavelength lateral dimensions in at least one lateral directions. A tunable metasurface is an optical metasurface where one or more of its sub-wavelength features has a tunable resonance. A metasurface can have a single feature, but it is more often configured as a 1D or 2D array of metasurface features.

The optical resonance can be a Fabry-Perot resonance, a plasmonic resonance or a coupled Fabry-Perot/plasmon resonance.

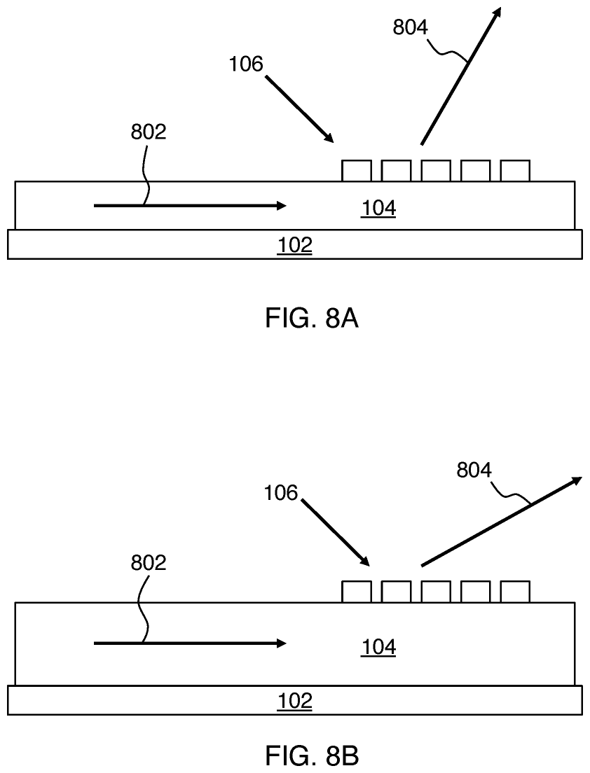

Some embodiments include a waveguide disposed such that light incident on the optical metasurface can couple to the waveguide at a coupling angle that depends on the thickness of the polymer (see FIGS. 8A-B).

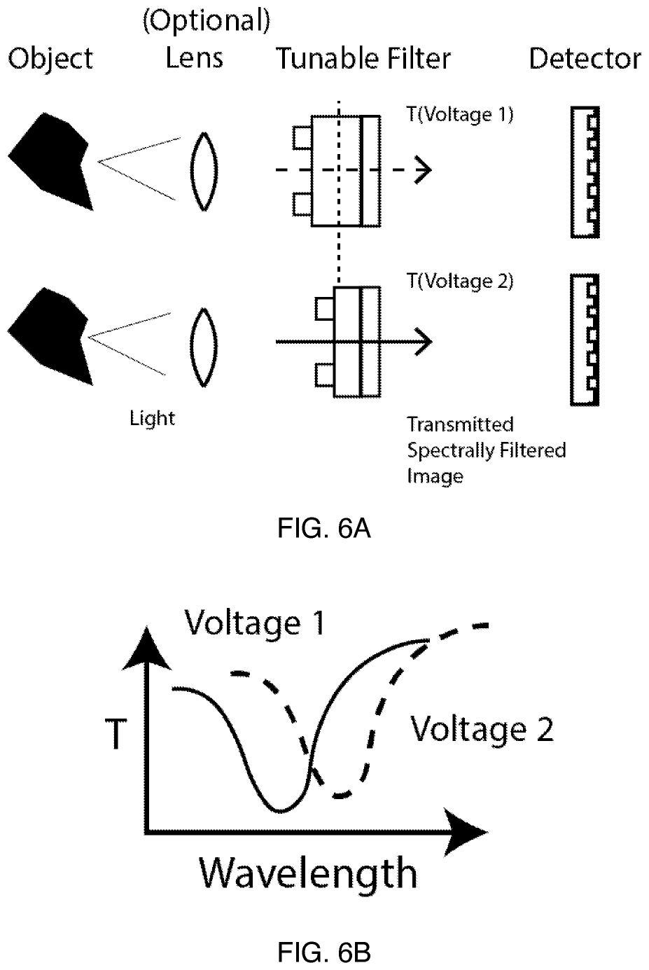

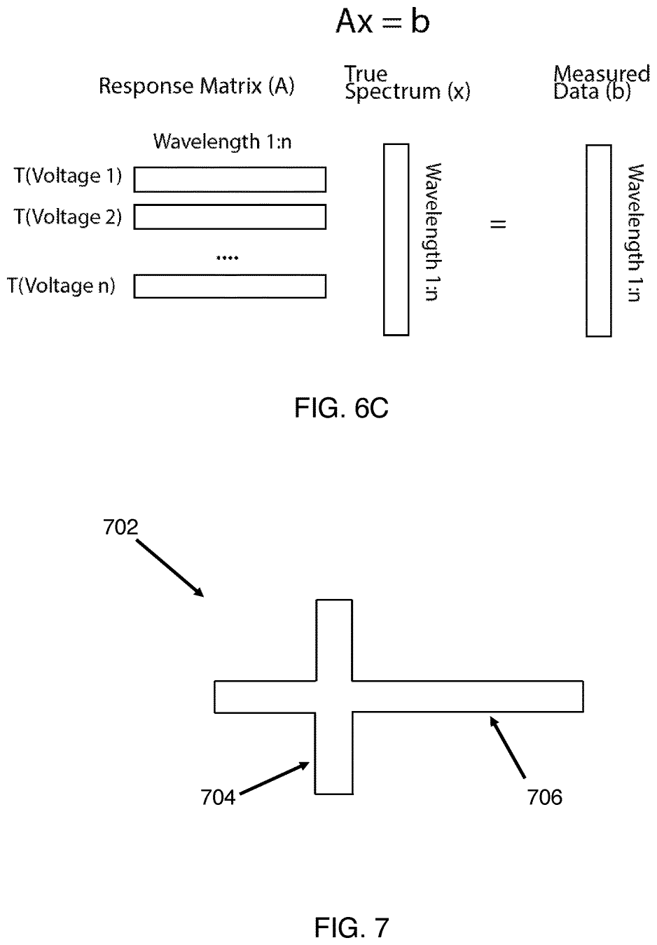

The apparatus can be configured to operate in reflection or transmission. Some transmissive embodiments are suitable for use in hyperspectral imaging applications (see FIGS. 6A-C)

The metasurface feature(s) can be asymmetric, so that polarization-dependence of the optical properties is provided, as in the example of FIG. 7.

The metasurface feature(s) can be configured as a 2D array of four or more metasurface features.

The apparatus can be configured to provide tunable beam steering in response to the voltage.

The electrochemical cell can include an ion gel electrolyte, or it can be a fluidic cell.

Another embodiment is a method of sensing a environmental stimulus, where the method includes:
disposing a sensor structure in an environment, where the sensor structure includes an optical metasurface having metasurface feature(s) having optical resonance(s) that are affected by the environment;
where the metasurface feature(s) include a first metal structure and a second metal structure sandwiching a polymer, and where the optical resonance(s) are affected by the environment at least via a change of thickness of the polymer;
observing the sensor structure with reflected and/or transmitted light to measure an optical signal from the sensor structure; and
relating the optical signal to a stimulus of interest in the environment.

The stimulus of interest in the environment can be: relative humidity, fluid pH, chemical species sensing, pressure, pressure exerted by a living cell or organism, electric field, and biologically generated electric field.

### B) Detailed Example

### B1) Introduction

Light is emerging as the most effective information carrier between humans and technology. For example, optical displays enable personalization of information consumption through smartphones and mixed reality (MR) eyewear. Miniaturized implantable devices for light delivery also open new applications in biophotonics, including minimally invasive sensing, endoscopic imaging, and optogenetic stimulation. The next generation of human-photonic interfaces will require compact devices that can dynamically manipulate the shape of optical wave fronts and their spectral properties with soft, stimuli-responsive and mechanically adaptive materials.

Optical metasurfaces appear to be a prime candidate for achieving these ambitious goals. Metasurfaces allow for the realization of essentially flat optical components through the sculpting of dense arrays of sub-wavelength optical resonators. However, metasurfaces are typically fabricated using rigid inorganic materials, leading to geometries that are static and fixed upon fabrication. Dynamic electrical tuning, which is necessary for scalable integration with established electrical control mechanisms, is limited by weak electro-refractive effects in the important visible spectral range. Furthermore, the Kramers-Kronig relations prescribe that significant tuning (i.e. index changes) naturally comes with notable absorptive losses. Integrating traditional rigid optical materials into intrinsically soft devices compatible with the human body is also technically challenging. Altogether, this motivates a search for new materials platforms and tuning concepts.

For inspiration, we turn to biological systems. Optical elements in nature are soft, deformable and broadly reconfigurable. Their giant tunability is commonly actuated by shape-changes in soft polymers, highlighting that geometry can be a powerful lever to alter optical responses. For example, the focal length of the cornea-lens system is adjusted by ciliary muscles, and color changes in chameleons are driven by contractions of chromatophores. Stimuli responsive optical components based on soft materials have, to date, been mostly focused on tuning of structural colors using photonic crystals and thin film Fabry-Perot cavities, or light shaping using micrometer- or millimeter-scale optical components such as micro-lenses. These devices, and recently demonstrated humidity responsive metasurfaces, demonstrate the notable tunability achievable with soft materials.

To expand the functionality of soft polymer-based metasurfaces, deterministic and arbitrary electrical control of the amplitude and phase is required. Local, sub-wavelength phase control allows for sculpting of propagating wave fronts, providing control over the flow of light. Microelectromechanical (MEMS) approaches are ideally suited for this purpose. Recent work has demonstrated that mechanical movement of silicon antenna arrays and plasmonic nano-antennae above a mirror allows for complete (0 to 2π) phase control and large amplitude modulation of scattered waves, highlighting the promise of geometric reconfiguration for phase control. Using soft materials to provide geometric reconfiguration in place of rigid MEMS devices could open new opportunities for wave front shaping with flexible, body worn technologies.

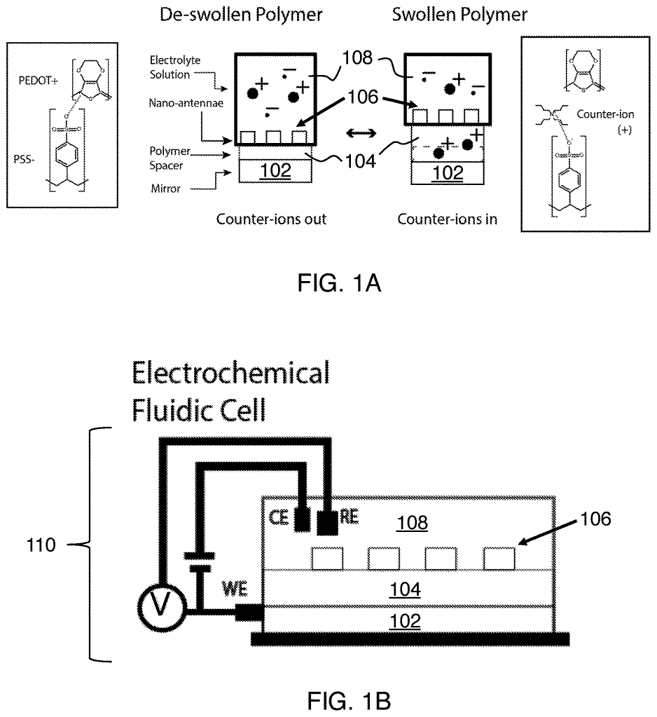

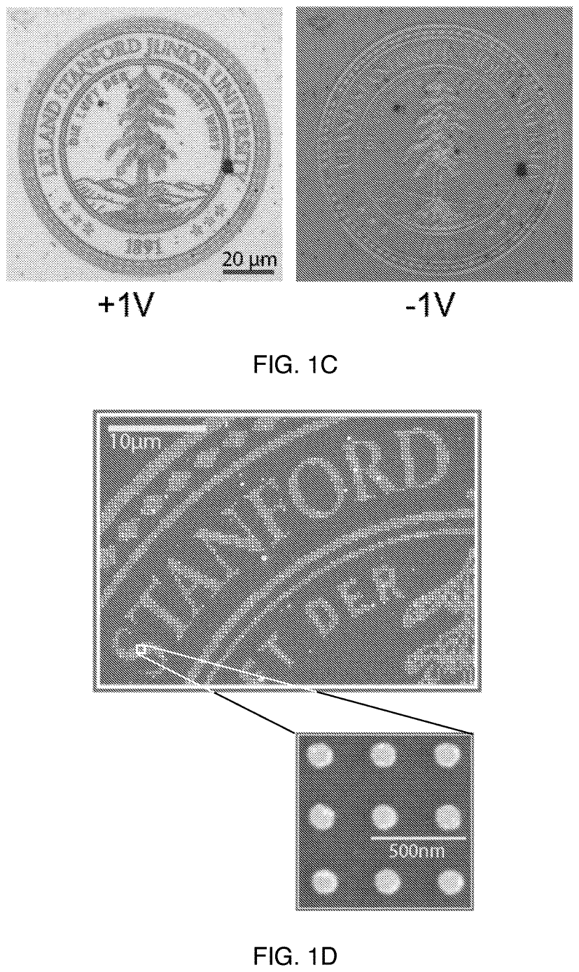

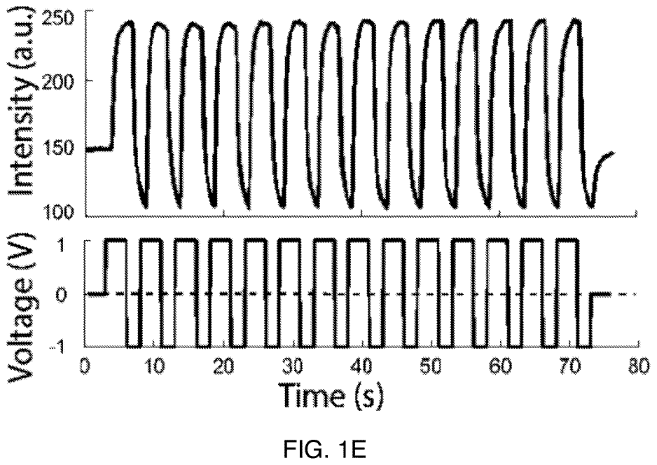

In this work, we use the electrochemically-driven swelling of the commercially-available polymer, PEDOT:PSS, to control the height of metallic nano-antennas above a mirror. We demonstrate active control of both reflected phase and visible color by tuning the geometry of Fabry-Pérot resonators (FIG. 1A). By changing the resonator dimension rather than relying on refractive index tuning, we can overcome the limitations set by Kramers-Kronig relations. This allows us to achieve large optical path length (OPL) changes at visible wavelengths without large absorption induced losses. Such desirable behavior is traditionally quantified by a figure of merit

$$( F O M = \frac{Δ O P L}{Δ k} = Δ n / Δ k )$$

given by the ratio of the real (n) and imaginary (k) parts of the refractive index. We find that swelling based tuning, evaluated based on strain (ϵ) induced OPL changes

$$( F O M = \frac{Δ O P L}{Δ k} = ϵ / Δ k ) ,$$

leads to improvements in the FOM by factors of over 20× at visible wavelengths in comparison to the highest performing electrochromic and phase change material devices. We capitalize on this extraordinary tunability to demonstrate high contrast, visible beam-steering devices in an ultra-thin form factor, suggesting amenability as a building block for future body-worn active photonic devices.

### B2) Operating Principles of Electrochemically Mutable Soft (EMuS) Metasurfaces

FIG. 1A is a schematic of the operating principle of Electrochemically Mutable Soft (EMuS) Metasurfaces. Our platform is a Fabry-Perot resonator comprised of patterned gold (Au) nano-antennae 106 separated from an Au mirror 102 by a mutable PEDOT:PSS spacer 104. Application of an electrochemical potential in electrolyte solution 108 leads to ion intercalation induced swelling/de-swelling. This modifies the thickness of the spacer and hence the geometry of the Fabry-Perot resonators. FIG. 1B is a schematic of the three-electrode electrochemical set-up (including a reference electrode (RE), counter electrode (CE), and working electrode (WE)). FIG. 1C is an optical micrograph of a fabricated metasurface pattern recreating the Stanford logo, demonstrating color switching by application of voltages of +1 V and −1 V, FIG. 1D is a scanning electron microscopy (SEM) image of the fabricated logo with an inset zoomed in on disc nano-antennae with a side length of 150 nm and periodicity of 340 nm. FIG. 1E shows reflected intensity (as measured by the pixel intensities of the red channel of an RGB camera) upon cycling between +1 and −1V with switching speeds of 3s.

The principle underlying the operation of EMuS metasurfaces is shown in FIG. 1A. Sub-wavelength metallic nanostructures can serve as plasmonic nanoantennae that can effectively absorb and scatter light at their resonant wavelengths. When they are placed in a dense array with sub-wavelength periodicity, they can serve as a metasurface that inherits some of the resonant behavior of the individual antennae. Placement of such a metasurface above a reflective metallic film creates an optical Fabry-Perot cavity. The coupling of the plasmonic resonance of the antennas in the array and Fabry-Perot resonances facilitates spectral and phase tuning. Our key innovation lies in achieving active manipulation of this distance by inserting an electrically swellable polymer film between the mirror and nanoantennae. By modifying the thermodynamic equilibrium between the free energy of mixing and elastic, electrostatic and osmotic free energies, we induce nanoscale swelling/de-swelling in electrolyte solution.

Specifically, the degree of swelling of the PEDOT:PSS spacer is reversibly tuned through electrochemically induced ion intercalation. PEDOT:PSS has fixed negative PSS− charges which are compensated by positive hole charges from conductive PEDOT chains. Application of negative voltages induces de-doping, where holes are depleted from the PEDOT chains. This results in a driving force for the intercalation of large positive ions from the electrolyte solution to compensate for the fixed PSS-charges, causing swelling. As a positive voltage is applied, doping the PEDOT chains with holes once more, the large positively charged ions in the electrolyte solution are driven out of the polymer, causing de-swelling. By changing the distance between the mirror and plasmonic nano-antennae, we thereby change the propagation phase shift within the Fabry-Perot cavity, enabling tuning of the spectral position of the resonance, along with the reflected phase and amplitude.

### Active Tuning of High Resolution Color Patterns

We use electron beam lithography to pattern gold nanoantennae onto a thin film of the commonly used transparent polymer, PEDOT:PSS, that has been spin coated on top of an optically thick gold (Au, 120 nm) mirror. Electrochemical tuning of spectral properties, and hence color, is carried out in a liquid electrochemical using a three-electrode setup (FIG. 1B) where potentials of +1 V, 0 V and −1 V are applied relative to an Ag/AgCl reference electrode. These measurements are made under unpolarized white light illumination.

We observe the voltage-dependent reflected structural color associated with arrays of nano-antennae patterned to recreate the Stanford logo (FIG. 1C). The antenna arrays, including discs 150 nm in diameter and 50 nm in height, are switched from green to orange by alternating between applied voltages of +1 V and −1 V. The 340 nm pitch of our fabricated plasmonic elements allows for color printing with a resolution near the diffraction limit of visible light, allowing for pixel densities exceeding 100,000 dots per inch (dpi), as observed in FIG. 1D. In contrast to systems using uniform top metallic films, our nano-patterning of the top metal allows for the majority of the polymer to be accessible to the electrolyte solution, allowing for uniform switching. The switching speed of our metasurfaces is investigated in FIG. 1E. The antenna arrays are switched at applied voltages of +1 V and −1 V while the reflected white-light intensity is recorded with an RGB camera. Isolating the red channel, we see that switching times of ~3 s are possible. The trajectory of the color evolution is dependent on the size of the antenna and periodicity of the array. A broad palette of colors can be accessed by application of intermediate voltages.

### B3) Spectral and Phase Responses

We investigate the spectral and phase responses of our devices as follows. For devices with sufficiently small periods (e.g. a 340 nm period), a normally-incident light wave only excites the zeroth-order modes in the device layers and in reflection. In this case the regular array of antennae serves as the second (metasurface) mirror of the Fabry-Pérot resonator. Its effective optical properties are set by the resonant properties of the antennae, their spacing and spatial arrangement. The resonant condition of an asymmetric Fabry-Pérot cavity having a reflecting mirror and antenna-array is met when the differential phase pick-up inside the cavity is an integer (m) multiple of 2π, yielding the following:

$${ϕ}_{propagation} + {ϕ}_{mirror} - {ϕ}_{plasmon} = 2 π m$$

Here, φₘᵢᵣᵣₒᵣ≈π for the Au mirror, and φₚₗₐₛₘₒₙ represents the engineerable phase pickup from the antenna-array. We achieve active tuning of the resonance by varying the phase shift from round trip propagation,

$${ϕ}_{propagation} = 2 kh = 2 ( \frac{2 π n}{λ} ) h ,$$

through electrically induced changes in cavity height (h).

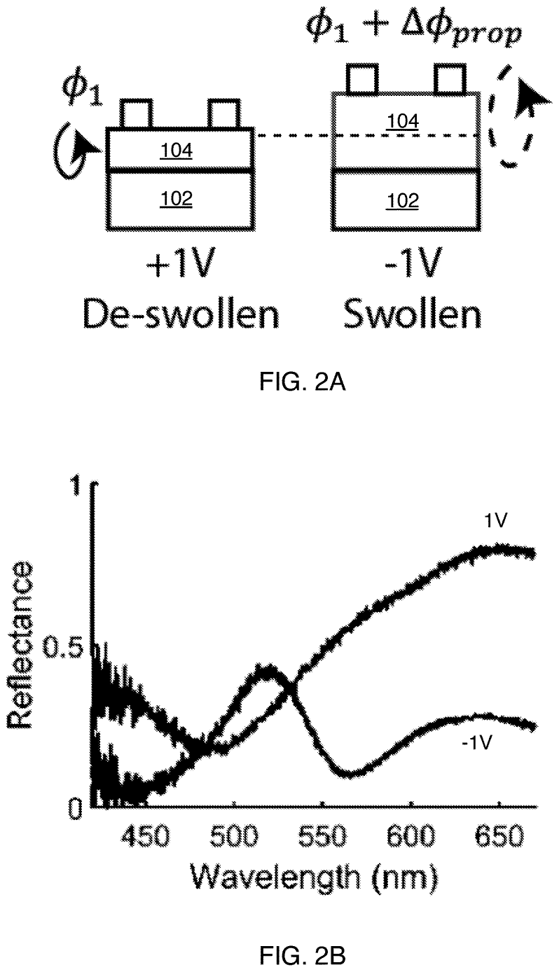

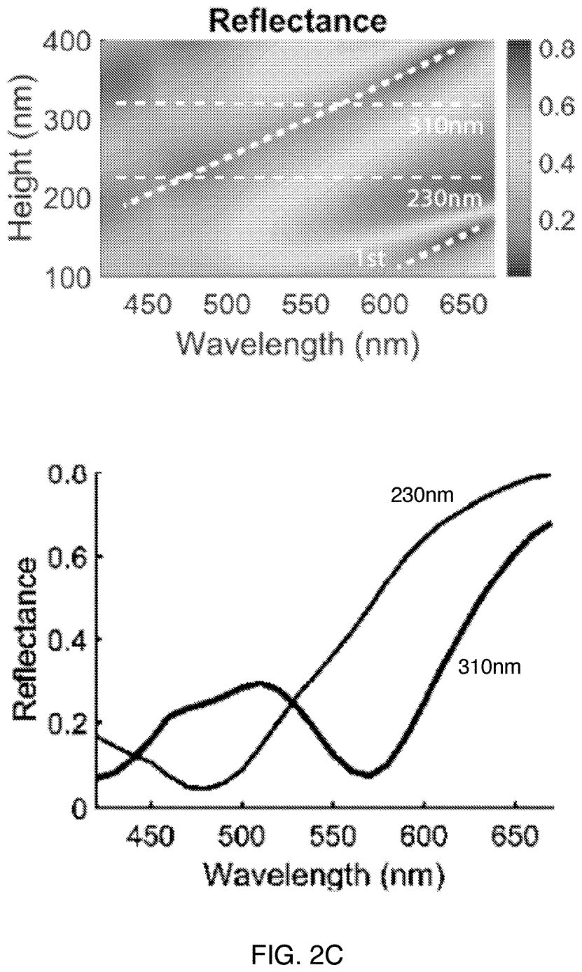

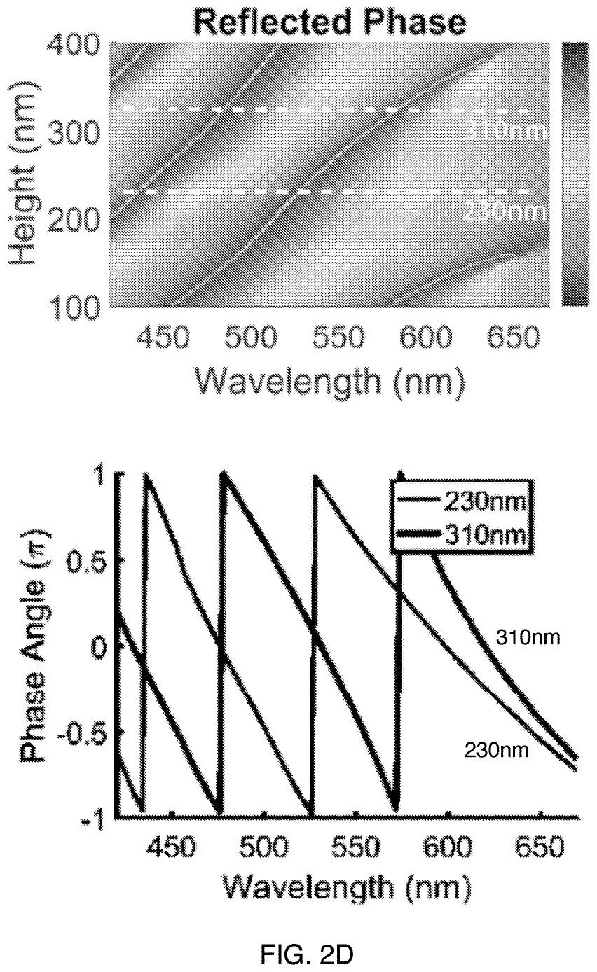

FIG. 2A is a schematic illustrating the origin of phase changes due the additional propagation phase during electrochemical height tuning. FIG. 2B shows measured experimental reflectance spectra at +1 and −1V for samples with a 150 nm diameter and 340 nm period. FIG. 2C (top) shows simulated reflectance spectra at a range of PEDOT:PSS heights, and FIG. 2C (bottom) shows simulated spectra plotted at two specific heights (230 and 310 nm, corresponding to dashed lines in the top image) corresponding to expected thickness at +1 and −1V. The positions of the Fabry Perot resonances are indicated by the dashed lines. FIG. 2D (top) shows simulated phase responses at a range of PEDOT:PSS heights, and FIG. 2D (bottom) shows simulated phase responses plotted at two specific heights (230 and 310 nm, corresponding to dashed lines in the top image).

Spectral maps of reflected intensity and phase at different spacer heights are calculated using Rigorous Coupled Wave Analysis (RCWA) (FIGS. 2B-C). At the resonance condition, light circulates inside the lossy cavity, as demonstrated by increased electric field confinement inside the cavity. This leads to increased absorption and a dip in reflectance. Swelling induced tuning of the resonance condition allows for shifting of this reflectance dip and hence control over the reflected color. We use previously published refractive index data for PEDOT:PSS, carried out using in situ electrochemical ellipsometry with the same electrolyte, as the material data for our simulations. This work found notable changes in the swelling degree of PEDOT:PSS with electrochemical potential, and relatively minor changes in the complex refractive index, (n, k).

We now compare results predicted by simulation with measured data. The measured spectral reflectance of the devices with 150 nm antennas at +1 V and −1 V are given in FIG. 2D. These show good agreement with the simulated spectral reflectance for thicknesses achieved at those applied voltages (FIG. 2B). These results suggested that a notable strain of ~34% can be obtained upon switching between +1 V and −1 V. We note that these simulations are conducted using a constant refractive index, for PEDOT held at 0 V in previously reported material data. PEDOT:PSS exhibits visible electrochromism, and its complex refractive index changes with voltage. However, these changes are small, particularly for the real part of the index which contributes to the effective path length, and we found that they have minor effects on the behavior of our cavities. They predominantly modulate the depth of reflectance dips, while maintaining the overall line-shape and the position of the resonance. Therefore, the design of active EMuS metasurfaces can to first order be conducted through consideration of the swelling degree of PEDOT:PSS while holding refractive index constant.

Dynamic control of the phase further expands the possibilities for EMuS metasurfaces. This point is illustrated in FIG. 2C, where we see that we can achieve phase control over a broad range (>π) through straightforward swelling induced control of the height (h). Here, swelling induced by switching from +1V to −1V provides changes in optical path length

$$( O P L = \frac{2 π n h}{λ} )$$

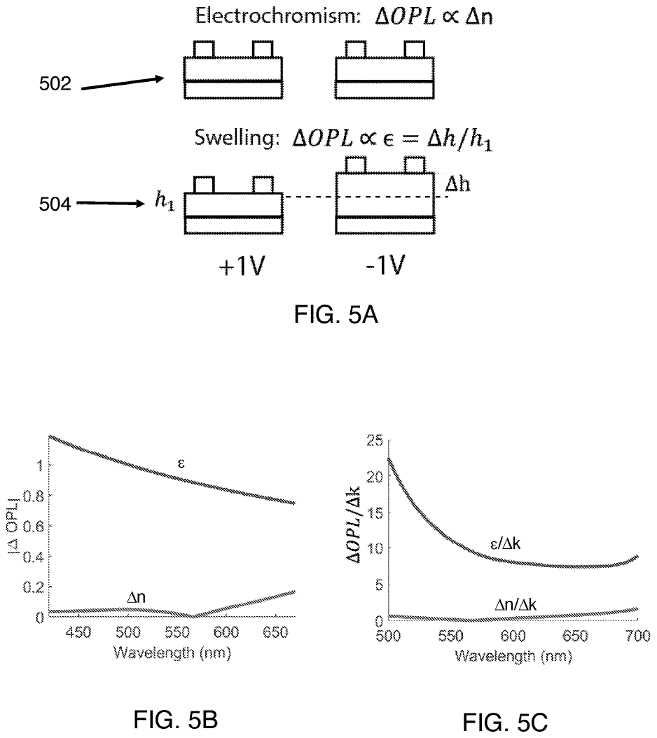

between 4 to 30 times greater than the refractive index (n) changes achievable by electrochromic modulation of PEDOT:PSS at visible wavelengths (FIG. 5B). A previously proposed figure of merit (FOM) for phase change material (PCM) based optical metasurfaces considers the change in optical path length per change absorption co-efficient (k) associated with some switching mechanism. Here,

$$F O M = \frac{Δ O P L}{Δ k} = \frac{Δ n}{Δ k} .$$

In our case, the FOM is given by

$$\frac{Δ O P L}{Δ k} = \frac{ϵ}{Δ k} ,$$

where ϵ is the strain from swelling. We find that swelling based tuning can provides FOMs up to 45× better than electrochromic tuning within the visible range (FIG. 5C). In contrast, state of the art materials based tuning systems typically provide FOMs of <2 at visible wavelengths (FIG. 5C), highlighting EMuS metasurfaces as a powerful platform for controlling phase responses.

### B4) Design of Gradient Metasurfaces for Beam Steering

The dependency of the phase responses on height can be engineered through careful design of the plasmonic antenna-array. We capitalize on the interplay between plasmonic and Fabry-Perot resonances to facilitate the design of actively tunable metasurfaces capable of dynamic wave front shaping.

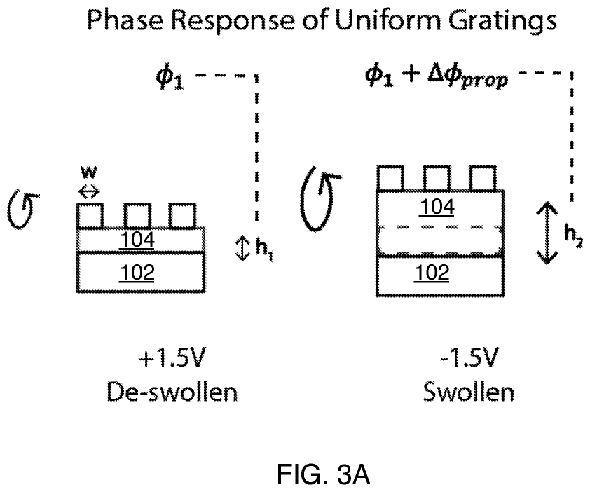

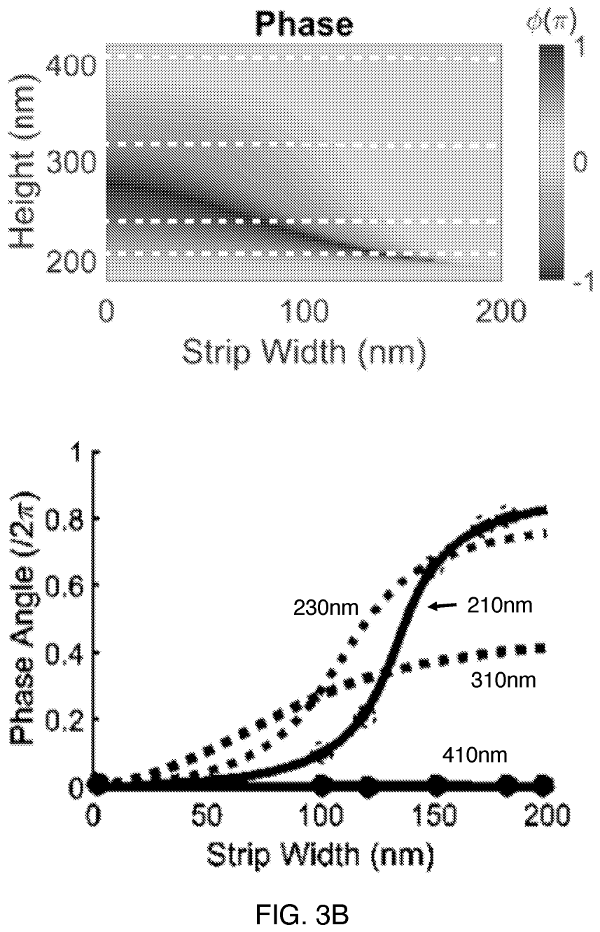

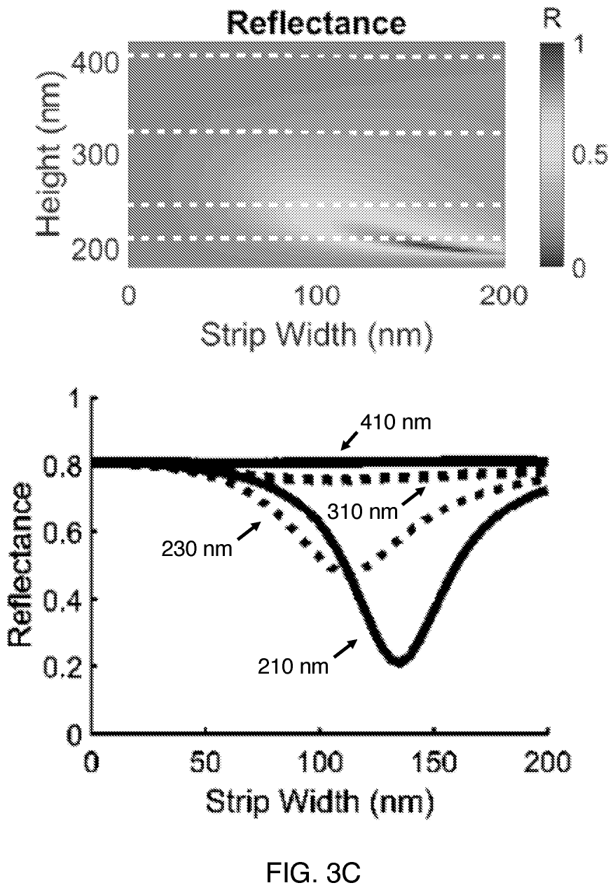

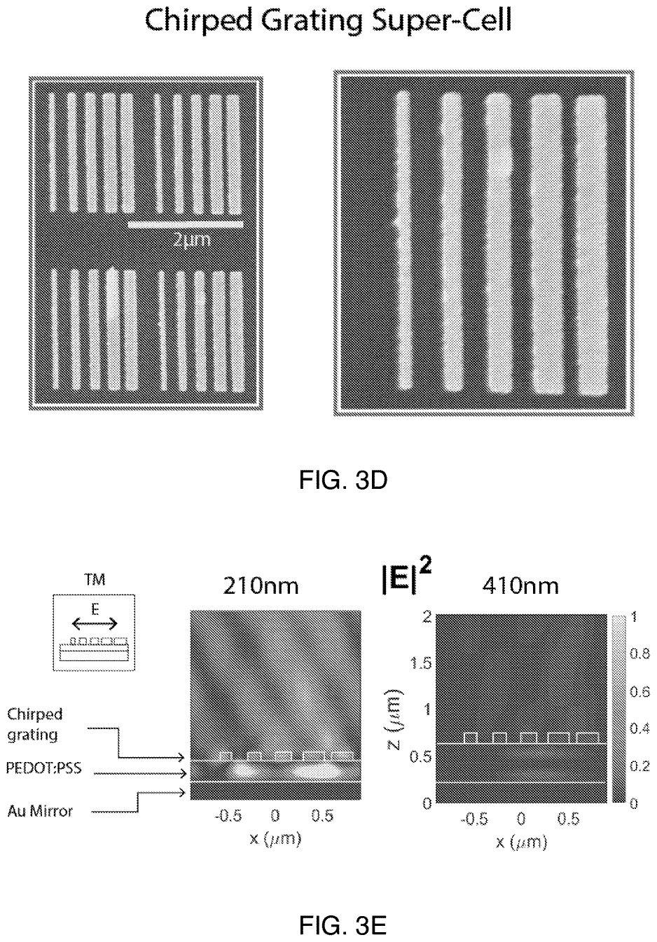

FIG. 3A is a schematic illustrating propagation phase (Δφₚᵣₒₚ) pick-up of uniform gratings due to swelling. FIG. 3B and FIG. 3C (top) show phase and reflectance maps, respectively, simulated at a range of PEDOT:PSS heights. FIGS. 3B and 3C (bottom) are corresponding phase and reflectance responses, respectively, plotted at four specific heights. Heights of 230 nm and 310 nm correspond to expected thicknesses at +1 and −1V. Heights of 210 nm and 410 nm correspond to expected thicknesses at +1.5V and −1.5V. FIG. 3D is an SEM image of fabricated periodic metasurface, and an expanded view of a single super-cell. FIG. 3E shows scattered-field simulations of the periodic super-cell metasurface representing the electric field intensity (|E|²) distribution in response to transverse magnetic (TM) illumination.

As a proof-of-concept for phase control, we consider the design of a chirped grating that can actively switch between diffracted orders as an archetypal height-tunable gradient phase metasurface. To guide the design of such devices, we first investigate the local reflection phase response uniform grating arrays as a function of height (FIG. 3A). We simulate the phase and reflectance of periodic arrays of metallic strips with different widths at different heights above a mirror (FIGS. 3B, C) for the wavelength of 650 nm.

Varying the strip width through a dipolar resonance leads to strong phase shifts between strips of different widths. Tuning of the height allows for control over excitation of the resonance, allowing these phase shifts to be effectively turned “on” and “off”. We observe that there is only a weak variation in phase with strip width at a height of 410 nm, whereas at 210 nm, the phase varies strongly with strip width in a graded manner (FIG. 3B). We then experimentally realize a periodic metasurface with a supercell having multiple strips with a thickness of 50 nm and widths graded from 0 to 200 nm (FIG. 3D). Strip widths are chosen to provide a phase gradient at a height of 210 nm and a flat phase response at a height of 390 nm. In this case, we assume that each plasmonic strip in the supercell serves as an individual antenna controlling the local reflected phase. Scattered field simulations of this final structure are used to verify our prediction of efficient steering. These results show that an incident light wave will be redirected into the 1st diffracted order when the height is 210 nm (FIG. 3E). At 410 nm, weak light matter interactions lead to minimal scattering and re-direction, allowing incident light to simply be specularly reflected. We note that achieving this range of heights requires a higher maximum swelling degree than achieved for the switching range of 1V to −1V (FIG. 2A). Prior data shows that the swelling degree can be doubled by extending the potential range to −1.5V, which we utilize in our experimental demonstrations.

### Experimental Demonstration of High Contrast Beam Steering

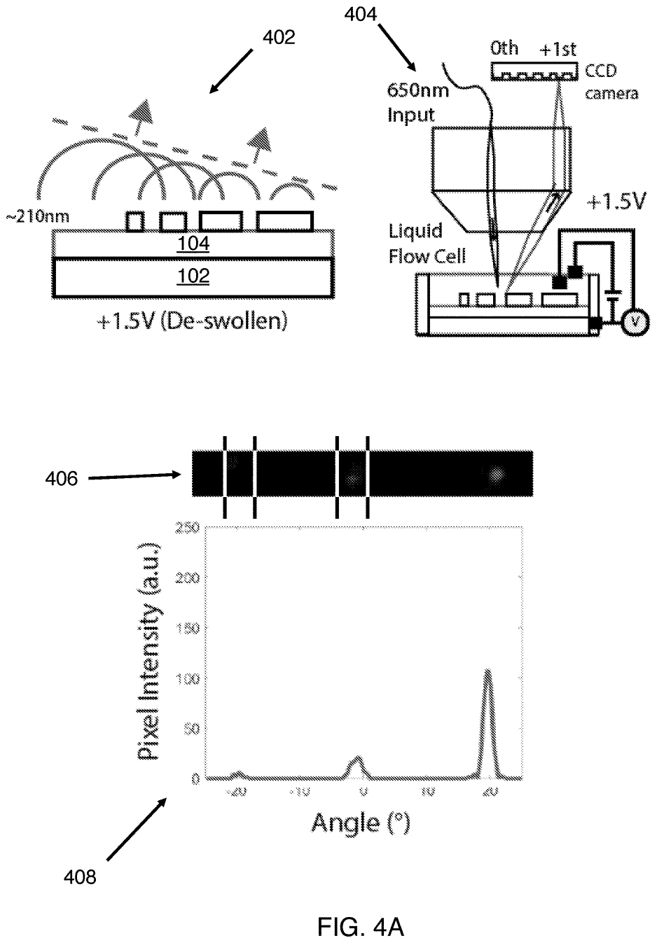

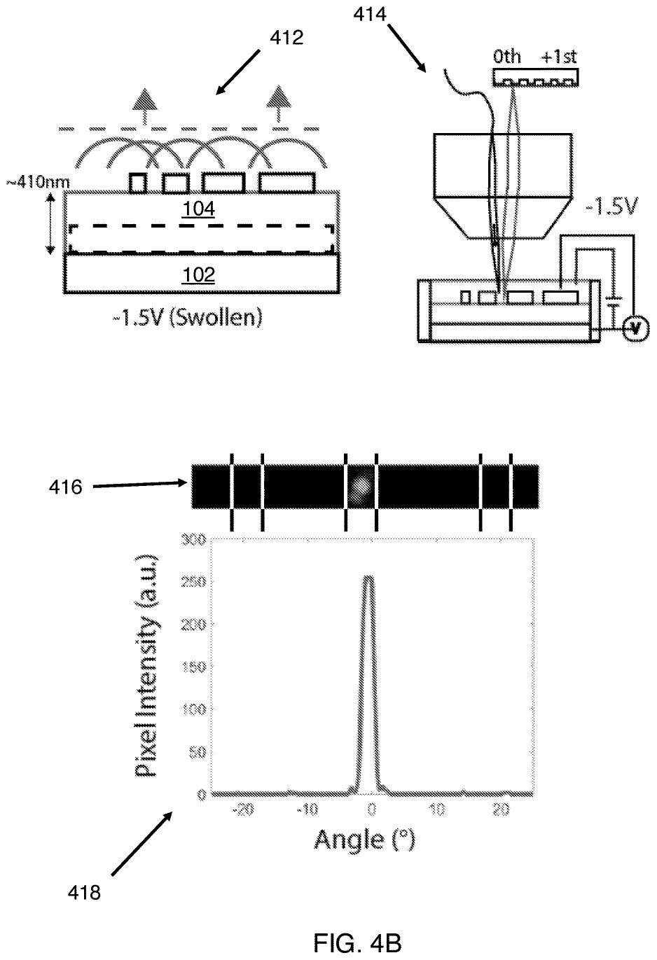

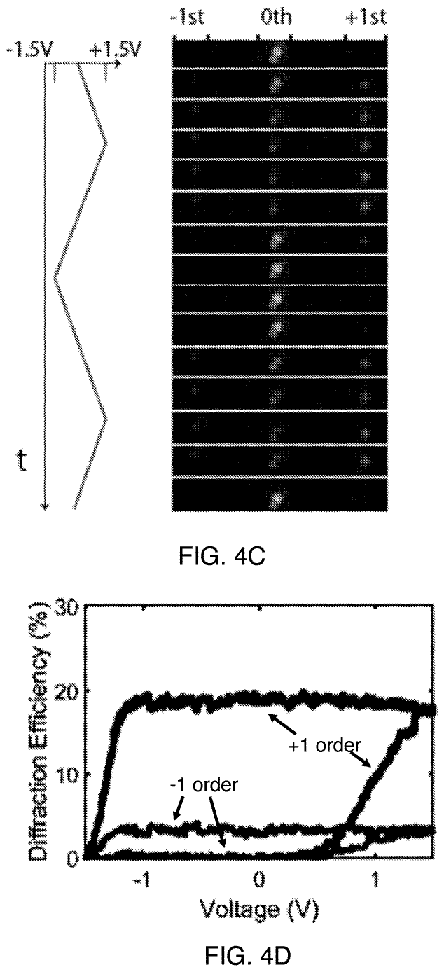

402 on FIG. 4A is a schematic of an individual device having polymer thickness 210 nm (de-swollen) showing the reflected wave redirection, similar to phased antenna arrays. The resulting beam steering is schematically shown in 404 of FIG. 4A. 406 and 408 on FIG. 4A show the corresponding camera image and intensity profile, respectively. 412 on FIG. 4B is a schematic of an individual device having polymer thickness 330 nm (swollen) showing the lack of reflected wave redirection. The resulting lack of beam steering is schematically shown in 414 of FIG. 4B. 416 and 418 on FIG. 4B show the corresponding camera image and intensity profile, respectively.

FIG. 4C shows selected camera images showing two cycles of active diffractive switching upon in-situ electrochemical cycling between −1.5 V and +1 V. The small secondary spot next to the zeroth-order beam represents a constant reflection from the glass coverslip used as part of our liquid flow cell.

FIG. 4D is a plot of diffraction efficiency vs. applied voltage shown for the +1 and −1 orders, demonstrating a hysteresis in the optical signal. Depending on the scan direction, the metasurface is in different states at OV.

By cycling the potential between −1.5V to +1.5V, this device can actively switch between the 0^{th} and 1^{st} diffracted orders as the PEDOT:PSS uniformly swells/de-swells (FIGS. 4A-D). We study this behavior by imaging the response of our metasurface in the Fourier plane, at a wavelength of 650 nm. At a voltage of +1.5 V (swollen), the height is close to 210 nm, where a strong phase gradient is experienced by the incident light wave, re-directing the beam into the 1st diffraction order (FIG. 4A) with an efficiency of 19%. At a voltage of −1.5 V (de-swollen), the metasurface height is close to 390 nm, where minimal phase gradient is experienced (FIG. 4B), and diffraction efficiency is reduced to below 0.5%. A key feature of our metasurface is the large modulation depth achievable by electrically-induced swelling. Our device almost fully switches off diffraction into the 1^{st} order, achieving a modulation depth of over 95% (FIGS. 4C-D). Our chirped design ensures that diffraction into the −1^{st} order is negligible. We note that due to a periodicity introduced perpendicular to the chirped direction, some energy is lost to diffraction orders in the perpendicular direction.

Unlike binary switching in other tunable systems such as phase change materials, we can access a set of continuous intermediate states, allowing for the intensity of the diffracted beam to be precisely controlled. This metasurface design methodology is generalizable to other arbitrary phase profiles, such as hyperboloids for reconfigurable lensing or other desired transfer functions.

### B5) Discussion and Outlook

By achieving deterministic active tuning of local phase at visible wavelengths, our system expands the functionality of soft polymer-based photonics. Tunable devices utilizing polymer swelling have mainly been focused on tuning of structural color or bulk diffraction. We note that electrochromic polymers have been used in electrically tunable metasurfaces. However, tuning is confined to specific spectral regions and is limited by constraints such as the carrier densities of the polymers. This limits the design possibilities for such devices. Furthermore, modulation of the real part of the refractive index, necessary for phase control, is minimal at visible wavelengths. When used for wave front manipulation, such devices have reported relatively low efficiencies of <1%, posing challenges for practical implementation.

In contrast, we highlight that our strategy of using polymer swelling to control the separation between metallic elements is broadly applicable to a range of spectral regions. With appropriate choice of metal and transparent, swellable spacer, our approach could enable efficient, full light field control at wavelengths ranging from UV to THz. In this work, the strong light-matter interactions of plasmonic resonators allow us to achieve relatively high peak efficiencies of >19%. Our demonstration of contrast ratios of >95% at visible wavelengths is enabled by our use of soft materials to modify the optical path length (OPL) of Fabry-Perot resonators. By using geometry as our primary tuning knob, we achieve large OPL changes without concurrent absorptive losses, overcoming the constraints imposed by the Kramers-Kronig relations.

These metrics highlight the relevance of EMuS metasurfaces for practical usage in emerging applications where phase control of visible light is crucial. For example, our approach could enable addressable holography directly on curved smart glasses or hydrogel contact lenses. Here, we are aided by operation of our devices at only ±1.5 V, which is favorable for compatibility with low-voltage complementary metal-oxide semiconductors (CMOS) chips (0 to 3.3 V), and the amenability of our metasurfaces to high density patterning. The industrial availability of PEDOT:PSS and its established usage in flexible electronic devices and existing wearable electro-chromic displays may assist its broader uptake. Metal films at the ultra-low thicknesses (<100 nm) required for EMuS metasurfaces are compliant and flexible, a feature that has been widely utilized in the field of flexible electronics. Therefore, our system can be implemented as an ultra-thin, sub-micron coating on flexible substrates, allowing for a great deal of flexibility in the development of body-worn devices.

Looking further ahead, EMuS metasurfaces could be used as a building block for applications which have to date been out of reach, such as flexible implantable light steering devices. For example, by incorporating swelling based phase control into grating out-couplers used in soft fiber-optics, the direction or spectral characteristics of outcoupled light could be controlled. We expect dynamic control over light fields could be advantageous for more spatiotemporally precise optogenetics or endoscopic bio-imaging. PEDOT:PSS has been widely used in implantable bioelectronic systems. Integration of other thiophene based polymers, which swell by up to 300% in aqueous electrolytes, could enable usage of EMuS metasurfaces in bio-integrated applications operating in aqueous conditions.

Exploration of alternate electrolyte systems, including solid state ionic gel electrolytes, could enable faster switching speeds or improved long term stability, advancing the broad utility of our devices. Such low footprint, soft and active photonic devices may open the door for seamless optical interfaces with the human body.

### B6) Supplemental Material

B6a) Electrochemical Tuning Vs. Electrochromic Tuning

FIG. 5A is a schematic outlining effect of different tuning mechanisms on OPL. FIG. 5B shows changes in the absolute value of

$$\frac{Δ O P L}{Δ 2 π}$$

based on refractive index changes vs. swelling. FIG. 5C shows changes in the ratio of the OPL to changes in absorption co-efficient

$$( \frac{Δ O P L}{Δ k} )$$

based on refractive index changes vs swelling.

Swelling provides access to greater absolute OPL

$$( = \frac{2 π n h}{λ} )$$

changes and

$$\frac{Δ O P L}{Δ k}$$

changes than tuning via electrochromic effects in PEDOT. We obtain Δk changes for a given voltage from previous literature. These values are similar across studies in different electrolyte systems and with different specific PEDOT additives. The strain is determined based on the swelling ratio predicted from comparison between our simulation results and experimental data as described above.

The FOM ratio in

$$\frac{Δ O P L}{Δ k}$$

is greatest where the PEDOT's Δk is lowest, reaching over 45 at shorter wavelengths.

### B6b) Transmissive Devices for Hyperspectral Imaging Applications

The tunable metasurface could be used in a transmissive manner by replacing the thick gold mirror with a partially transmissive thin gold film, or nano-patterning of the bottom surface to create a partially transmissive metasurface. Such a tunable metasurface could act as a tunable filter as part of an imaging system or other optical system. In one embodiment, it is placed in the optical path, before the detector, and either prior to or after a lens system, as schematically shown on FIG. 6A.

The transmission spectrum can be tuned with application of voltage. This allows for retrieval of a full spectral image, which contains spectral information for each pixel in the image, by capturing a set of images while voltage is being modulated (each voltage having a different spectral filter response, as schematically shown on FIG. 6B), and then computationally reconstructing the spectra from those set of measurements. This reconstruction, in one form, could be implemented by a simple matrix inversion of the form Ax=b, where x is the true incident spectrum to be reconstructed, b is the measured data and A is a response matrix of the transmissivity at a range of wavelengths. This reconstruction is schematically shown on FIG. 6C.

### B6c) Polarization Dependence

The preceding examples show metasurfaces having symmetric structures. It is also possible for metasurface features to be asymmetric, which can be useful for polarization control. In the example of FIG. 7, an asymmetric metasurface feature 702 has a short arm 704 and a long arm 706 at right angles to each other. In a configuration like this, the two arms will be in resonance at different polymer thicknesses, thereby enabling polarization control according to the above-described principles.

More specifically, the resonance on each arm is excited by a different polarization. As the length of one arm is different to the other arm, they will have different particle resonance conditions, and the full arm/mirror system will be at resonance at different heights above the mirror (due to the different phase dependencies on height of the different arm lengths). Therefore, incident light at a given polarization, at a given height will be more strongly scattered than light of a different polarization, causing some rotation of polarization state. By changing the swelling degree, we change the relative scattering strengths from each polarization, thereby allowing control over the degree of polarization.

In another implementation, we can include a polarization transforming structure above the mirror. By moving it from a node to an anti-node of the reflected field above the mirror, we are able to change the degree to which polarization transformation occurs.

The use of periodic arrays of patterned, designer particles allows for control of polarization responses over a wide area with larger sensitivity/response. For example, such a system could also be used for chiral sensing of enantiomeric molecules. These are biomolecules with some “handedness” that is difficult to distinguish by other means. The refractive index of these molecules in chiral fields with different handedness is shown to be significantly different. Our system provides a method of carrying out polarimetry where we tune the polarization response and hence chirality of the reflected field, and can observe the molecular response at different output polarizations. This allows for significantly more data to be collected than from evaluation at a fixed output polarization. For further description of sensing applications, see section B6e below.

### B6d) Tunable Waveguide Coupler

Another application of this work is tunable waveguide coupling, as in the example of FIGS. 8A-B. Here the nanofeatures 106 are configured as a grating and the thickness change in polymer layer 104 leads to a change in the coupling angle between free space radiation 804 and guided mode 802 as shown. Output coupling is shown, but the principle is the same for input coupling. The excitation of, and radiation from these guided modes also provides a separate mechanism by which we can control incident free space light.

One implementation is coupling to a metal-insulator-metal (MIM) waveguide modes. An MIM geometry is known to support waveguide modes with very high field localization and hence sensitivity to the material serving as the insulator spacer. In this instance, we allow the polymer to serve as the insulator spacer. We note that it is typically not possible to couple to these modes from free space due to the impossibility of phase matching. Therefore light incident on the structure would be directly reflected. However, by patterning the top metal layer with some periodicity, such that

$${k}_{incident} sin θ + m ( \frac{2 π}{a} ) = {k}_{MIM mode} ,$$

we allow the phase matching condition to be satisfied. We can then couple to this waveguide mode—by reciprocity, light that can excited the waveguide mode can also be coupled back out to free space. The guided mode can also be excited by end coupling via a fiber. If we consider monochromatic incident light, then by changing grating parameters, we can change the allowed in and outcoupling θ by changing grating parameters.

This provides mechanisms to tune free space light. For example, if we can couple in light at some wavelength at a location using a given grating parameter, allow it to propagate for some distance in an unbroken MIM waveguide and then introduce another top layer grating with a different periodicity. This will then redirect the output beam at a different angle. Alternatively, we can also tune color through this system. Propagation of light in a lossy MIM system, especially with absorbing “insulator” spacer layers, will result in strong light absorption that can be engineered.

By tuning the thickness of the spacer polymer layer as per our described methods, we can thereby tune the diffracted angle or reflected color of our system. As this relies on spatially delocalized waveguide modes that spread over a large area, we can achieve resonances that are more localized in k and hence have sharper wavelength features.

We note that the above system can also function in transmission if the bottom metal layer is sufficiently thing, allowing for tunable transmissive filters and beam steering elements as well.

In another implementation, we can excite guided lattice resonances through interactions of particles arranged in a periodic lattice (without guiding in an MIM geometry).

In another implementation, we can use the particles (which scatter light with a range of k values) to couple light to propagating surface plasmon modes localized to the base mirror metal, polymer interface, with efficiencies that depend on the height of the particles above the metal.

We note also that the use of soft polymers in these waveguides (known in some industrial settings as light pipes) could allow for the creation of curved and flexible optical components, with significant potential for application in the fields of wearable photonic elements. This could find use in applications including but not limited to AR/VR, where solid, rigid diffractive elements for guiding and delivery of light are widely used.

### B6e) Sensing Applications

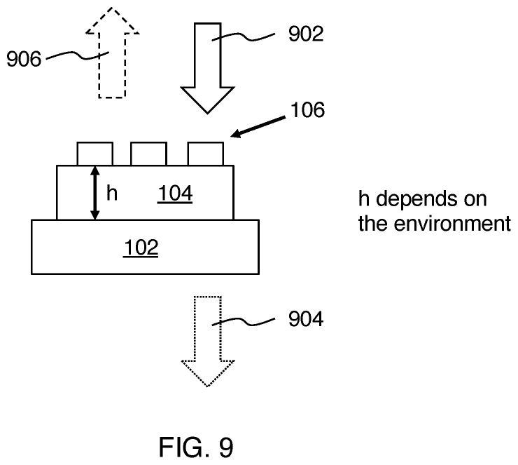

FIG. 9 shows a sensing concept enabled by embodiments of the invention. Since the thickness h of polymer 104 depends on the environment, optical measurements of the metasurface provide an optical probe of the environment. Typically the metasurface will be illuminated with incident light 902 and then characterized in transmission 904 and/or reflection 906 to provide suitable sensor signals. Calibration can be employed if quantitative results are needed.

The direct optical sensing of solvation energy, humidity, salt or pH is possible. However, the polymers can additionally be functionalized to impart specificity.

In one implementation, we couple enzymes, which could include glucose oxidase, to our system, either in solution or immobilized on the substrate or within the polymer. The presence of the analyte, in this instance glucose, will result in catalytic activity and production of hydrogen peroxide/formation of acidic gluconic acid, resulting in swelling of the polymer. This can be sensed optically. This system can in principle incorporate a plurality of enzymes employing different catalytic systems.

The system can also be sensitive to various volatile organic gases. By modifying a base polymer with different functionalizations (including but not limited to, different alkyl chains) having varying surface energies interaction degrees to different gases, the response of a chemical vapor to many of these functionalized systems can be sampled, allowing for a pattern recognition approach to gas detection. Such concepts have been explored with multi-layer photonic crystals. Our approach in contrast can provide faster responses and be engineered for larger scale integration (for big data approaches) by semiconductor manufacturing approaches, allowing for greater scalability and throughput. Such a system could for example, act as a nano-optic sticker to detect food spoilage.

Additionally, physical fields such as pressure, which directly deform the soft polymer through mechanical forces, and electric fields which introduce swelling by inducing ion flow, can also be sensed. One particular usage lies in real time spatial imaging of pressure fields or electric fields generated from biological systems (e.g. cells, including mechanically active migrating bacteria, or electrically active cells and tissue including neurons).

1. Apparatus for controlling phase and amplitude of light, the apparatus comprising:
an electrochemical cell; and
an optical metasurface including at least one metasurface feature having an optical resonance, wherein the at least one metasurface feature includes a first metal structure and a second metal structure sandwiching a polymer;
wherein the optical metasurface is disposed within the electrochemical cell;
wherein a thickness of the polymer between the first metal structure and the second metal structure is electrochemically tunable by applying a voltage to the electrochemical cell, thereby altering one or more optical properties of the optical resonance to control a phase response and an amplitude response of the optical metasurface.

2. The apparatus of claim 1, wherein the optical resonance is selected from the group consisting of: Fabry-Perot resonances, plasmonic resonances and coupled Fabry-Perot/plasmon resonances.

3. The apparatus of claim 1, further comprising a waveguide disposed such that light incident on the optical metasurface can couple to the waveguide at a coupling angle that depends on the thickness of the polymer.

4. The apparatus of claim 1, wherein the apparatus is configured to operate in reflection.

5. The apparatus of claim 1, wherein the apparatus is configured to operate in transmission.

6. The apparatus of claim 5, wherein the apparatus is included in a hyperspectral imager.

7. The apparatus of claim 1, wherein the metasurface feature is asymmetric, whereby polarization-dependence of the optical properties is provided.

8. The apparatus of claim 1, wherein the at least one metasurface feature is configured as a 2D array of four or more metasurface features.

9. The apparatus of claim 8, wherein the apparatus is configured to provide tunable beam steering in response to the voltage.

10. The apparatus of claim 1, wherein the electrochemical cell includes an ion gel electrolyte.

11. The apparatus of claim 1, wherein the electrochemical cell is a fluidic cell.

12. A method of sensing a environmental stimulus, the method comprising:
disposing a sensor structure in an environment, wherein the sensor structure includes an optical metasurface having at least one metasurface feature having an optical resonance that is affected by the environment;
wherein the at least one metasurface feature includes a first metal structure and a second metal structure sandwiching a polymer, and wherein the optical resonance is affected by the environment at least via a change of thickness of the polymer;
observing the sensor structure with reflected and/or transmitted light to measure an optical signal from the sensor structure;
relating the optical signal to a stimulus of interest in the environment.

13. The method of claim 12, wherein the stimulus of interest in the environment is selected from the group consisting of: relative humidity, fluid pH, chemical species sensing, pressure, pressure exerted by a living cell or organism, electric field, and biologically generated electric field.
